(19) United States
(12) Patent Application Publication
(10) Pub. No.: US 2026/0198434 A1
(43) Pub. Date: Jul. 16, 2026

(54) High Density Vertical Farming

(71) Applicant: PINTERRA AGRITECH PRIVATE LIMITED, Bidadi (IN)

(72) Inventor: GOSAKAN ARAVAMUDAN, Bengaluru (IN)

(73) Assignee: PINTERRA AGRITECH PRIVATE LIMITED, Bidadi (IN)

(21) Appl. No.: 18/863,637

(22) PCT Filed: Dec. 14, 2023
(86) PCT No.: PCT/IN2023/051182

§ 371 Date: Nov. 6, 2024

(30) Foreign Application Priority Data
Mar. 7, 2023 (IN) 202341015333

(51) Int. Cl. A01G 31/02; A01G 24/46; A01G 31/04

(52) U.S. Cl. CPC A01G 31/0231; A01G 31/042; A01G 24/46

(57) ABSTRACT

The apparatus described herein advantageously eliminates the need for plant plugs/growing media for seeds. An expansive sheet expands as the plants grow on the sheet. A vertically aligned plant supporting expansive structure comprises a front layer of a corrugated plastic with an elastic memory that supports the plant from seed to harvest. A rear layer of a thin film cellulosic disposable and biodegradable membrane holds on to the rear of the front layer by surface tension of a nutrient solution. Artificial plant grow lighting illuminating plants supported on the front layer. Aeroponic misters are positioned behind the rear layer, wherein two of the vertically aligned plant supporting expansive structures with their respective rear layers face the misters and create an enclosed aeroponic misting space.

### CROSS-REFERENCE TO RELATED APPLICATIONS

This application is a PCT application that claims priority to and the benefit of the non-provisional patent application titled “High density vertical farming”, application number 202341015333, filed in the Indian Patent Office on 7 Mar. 2023.The specification of the above referenced patent application is incorporated herein by reference in its entirety.

### BACKGROUND

This invention in general relates to agricultural equipment, and specifically refers to a high density vertical farming components and system.

The Covid pandemic has exposed the vulnerability of the food system, and has reinforced the need to grow food locally. In order to grow food locally, at the point of consumption or near the point of consumption, and to be economically comparable to regular agriculture field production, the productivity of locally grown food must be high, planting density must be extremely high and the energy consumption must be low. There is an unmet need to increase the density of planting in orders of magnitude more than the productivity of existing agricultural and the currently available controlled environmental agriculture systems. Current agricultural system involve plantations in fields with transport taking time in the order of weeks or days over long distances.

With the given agricultural productivity per acre of land, by 2050 we will run out of agricultural land to feed the growing population. There is an urgent need to develop growing systems with increased productivity. In addition to the lack of sufficient arable land by 2050, we may run short on energy for agricultural activities. In parallel, there is a need to reduce the labor required for farming. There is an urgent need to bring in automation even in developing countries. We are running out of fresh water for farming operations, and we need to find a way to grow food even in desert like conditions through a highly productive version of controlled environment agriculture (CEA). We need to significantly increase the density of plants grown to make CEA economically viable. We need to reduce pollution and waste as a result of fertilizer application. Currently, wasted fertilizer runoff in fields equates to almost 40 to 60%. This runoff causes water pollution in rivers downstream. We need to reduce or eliminate pesticide application.

In current hydroponic and aeroponic systems, some form of plug is used to germinate the seed and anchor it to the wall of the hydroponic or aeroponic system. Examples of plugs include cocopeat in a plastic holder, rockwool in a plastic holder, Polyurethane foam, plastic foam, rubber foam, sponges etc. The growing medium in these plugs are typically of one time use, and add to production costs. If they are to be reused, they need to be sterilizied with chemicals, costly and environmentally unfriendly process. In addition, these media are a source of contamination in an otherwise sterile hydroponic or aeroponic system. In addition, a separate germination unit is required using these plugs, and these plugs are then transplanted onto the main growing station. This separate germination unit and the added process of transplanting seedlings is a significant cost factor in existing controlled environment agriculture plant growing systems. Hence, there is an unmet need to eliminate growing media.

A significant part of the LED lighting applied at the seedling stage does not contribute to plant growth. Most of the photons miss the sprouting cotyledons or initial leaves, and lost in the gaps between the leaves, and wasted/absorbed onto the media surface, such as the surface of cocopeat or other growing media. Hence, there is an unmet need to ensure that most of the light emitted from the LED (such as at least 70%) strikes a leaf or plant surface and directly contributes to photosynthesis.

In some plant growing systems, seedlings are planted on cloth substrate. In certain applications, these cloth substrates need an external scissor like structure to fold and unfold. Once seeds are placed on these cloth substrates, such as on microfleece cloths, the roots penetrate the cloth and reach the nutrient media behind the cloth. After harvest, the roots of the harvested plant must be extracted from the cloth for the cloth to be reused. Given the possibility of residues left after the cumbersome process of root extraction, the cloth substrate needs to be sterilized. Compared to sterilizing a clean smooth surface, sterilizing a cloth consumes significantly higher amounts of sterilizing agents such as bleach or hydrogen peroxide.

In current systems, there is an unmet need to save energy by ensuring that the photons emitted from the artificial light source hits a leaf, and is not wasted on striking the underlying surface between below the plants.

### SUMMARY OF THE INVENTION

Described herein is an apparatus and system for high density aeroponic vertical farming.

The apparatus described herein addresses the above unmet needs.

Advantageously, the apparatus described herein eliminates the need for plant plugs/growing media for seeds. Described herein is a front sheet facing the LED lights with an expansive structure. The expansive structure is a corrugated structure. In other embodiments the expansive sheet can expand in two dimensions, for example with pyramidal expansive origami type foldings. The expansive structure is two layered, a front structural layer, and a rear thin film layer. The thin film that is held by water surface tension adheres to the rear of the front structural sheet. The seedling germinates and the roots displaying gravitrophism, grow towards gravity downwards and grows aeroponically into the rear misted space.

Advantageously, the apparatus described herein conserves energy. The plant expansive structures that house the plants increase photon capture efficiency and therefore provide significant energy savings. In all the expansive stages, as the plant grows, the spacing between the plants increase, and therefore light is not wasted by striking the underlying surface, and instead the photons emitted from the LEDs strike the surface of the plant. The apparatus described herein advantageously ensures that most of the light emitted from the LED strikes a leaf or plant surface and directly contributes to photosynthesis. In another embodiment, the LED lights are positioned at a distance above the germinating seedlings, and angled in such a manner that the beam substantially illuminates the top of plant leaves/canopy and even if a photon were to miss a leaf, it would travel downwards and strike the lower exposed leaf top. Hence, LED light is not wasted striking the sheet.

Advantageously, the apparatus described herein increases planting density and yield per unit floor space. The compressed plant expansive structures occupy lesser space than regular growing surfaces of the current art.

Described herein is a vertical aeroponic plant growth system. A vertically aligned plant supporting expansive structure comprises a front layer of a corrugated plastic with an elastic memory that supports the plant from seed to harvest, and a rear layer of a thin film cellulosic disposable and biodegradable membrane holds on to the rear of the front layer by surface tension of a nutrient solution. Artificial plant grow lighting illuminate plants supported on the front layer. Aeroponic misters are positioned behind the rear layer. Two of the vertically aligned plant supporting expansive structures with their respective rear layers face the misters and create an enclosed aeroponic misting space.

Multiples of the vertically aligned plant supporting expansive structures are compressed at different levels and jointed continually to create continuous long plant growing surfaces.

The continuous vertically aligned plant supporting expansive structures form an open loop aeroponic chamber.

In another embodiment, the continuous vertically aligned plant supporting expansive structures form a closed loop aeroponic chamber.

The vertically aligned plant supporting expansive structures is expanded at the stage when plants overgrow and their canopy or leaves begin to over shade each other.

The vertically aligned plant supporting expansive structures is compressed at the level wherein atleast 95% of light from said artificial lighting strikes a plant part rather than the surface of said front layer.

The roots from plants positioned one above the other on the vertically aligned plant supporting expansive structures interlock and therefore create a continuous grid support structure that holds the plants onto the vertically

Sprockets with tooth engage with the folds of the corrugation of the front layer, and drives the movement of the vertically aligned plant supporting expansive structure.

The rear layer is pre-imbibed with one or more of slow release fertilizers, humic acid, activated carbon or charcoal.

In another embodiment, the vertical aeroponic plant growth system, comprises a vertically aligned plant supporting structure, comprising a front layer of a plastic that supports the plant from seed to harvest, a rear layer of a thin film cellulosic disposable and biodegradable membrane that holds on to the rear of the front layer by surface tension of a nutrient solution. Artificial plant grow lighting illuminate plants on the front layer. Aeroponic misters are positioned behind the second layer. Two of the vertically aligned plant supporting expansive structures with their respective rear layers face said misters and create an enclosed aeroponic misting space.

In another embodiment, the vertically aligned plant supporting structure, comprises a front layer of a plastic with a first set of cutouts that supports the plant from seed to harvest, and a rear layer of a plastic membrane with a second set of cutouts. The rear thin plastic membrane holds on to the rear of the front layer by surface tension of a nutrient solution. The first set of cutouts and set second set of cutouts are offset and do not overlap.

### BRIEF DESCRIPTION OF THE DRAWINGS

The foregoing summary, as well as the following detailed description of the invention, is better understood when read in conjunction with the appended drawing. For illustrating the invention, exemplary constructions of the invention are shown in the drawing. However, the invention is not limited to the specific components disclosed herein. The description of a component referenced by a numeral in a drawing is applicable to the description of that component shown by that same numeral in any subsequent drawing herein.

FIG. 1A illustrates a fully expanded corrugated front sheet with cutouts.

FIG. 1B illustrates a thin rear membrane.

FIG. 1C illustrates a fully expanded corrugated front sheet with a thin rear membrane attached by water surface tension to the front sheet.

FIG. 1D illustrates a partially compressed corrugation of the front sheet with rear membrane.

FIG. 1E illustrates a fully compressed corrugation of the front sheet with rear membrane.

FIG. 2A illustrates a fully compressed corrugated front sheet with cutouts, along with seeds positioned in the cutouts.

FIG. 2B illustrates a first level of expansion of the corrugation of the front sheet with rear membrane, displaying germinated seeds.

FIG. 2C illustrates a second level of expansion (higher than the first level of expansion), displaying young seedlings.

FIG. 2D illustrates a third level of expansion (higher than the second level of expansion), displaying seedlings.

FIG. 2E illustrates a fourth level of expansion (higher than the second level of expansion), displaying young plants.

FIG. 3A illustrates a front sheet with cutouts.

FIG. 3B illustrates a roots penetrable thin film membrane.

FIG. 3C illustrates seed placements in the cutouts with the rear backing of a root penetrable thin film membrane.

FIG. 3D illustrates seedling growth in the cutouts with the rear backing of a root penetrable thin film membrane.

FIG. 4A illustrates a front sheet with cutouts.

FIG. 4B illustrates a thin plastic film with cutouts.

FIG. 4C illustrates seed placements in the cutouts with the rear backing of the thin plastic film with cutouts.

FIG. 4D illustrates seedling growth in the cutouts backing of the thin plastic film with cutouts.

FIG. 5A illustrates a plant expansive structure with L angles attached at the distal side ends.

FIG. 5B illustrates an L angles, that is used for attaching at the distal side ends of the plant expansive structure.

FIG. 6 illustrates a side elevation view of discrete plant expansive structures with L angles and L angle joint accessories used to join successive plant expansive structures.

FIG. 7 illustrates a top sectional view of the continuous long plant expansive structure with plants in multiple stages of growth.

FIG. 8A illustrates a side view of the frame that supports the plant expansive structure.

FIG. 8B illustrates a sectional view of the frame that supports the plant expansive structure.

FIG. 9 illustrates a surface tension attached two layered material displaying the interlocking of roots between upper and lower plants.

FIG. 10 illustrates a specially teethed sprocket driving the controlled movement of the plant expansive structure.

FIG. 11 illustrates a top view of open loop based continuous plant expansive structures being successively expanded in different stages.

FIG. 12 illustrates a top view of closed loop based continuous plant expansive structures being successively expanded in different stages.

FIG. 13A illustrates a compressed plant expansive structure.

FIG. 13B illustrates an almost fully expanded plant expansive structure (>80% expanded state).

FIG. 13C illustrates the plant expansive structure after the fully expanded plant expansive structure of FIG. 13B is released to come to its natural compressed state due its elastic memory.

FIG. 14 illustrates an active component level architecture of an aeroponics system.

### DETAILED DESCRIPTION OF THE INVENTION

For the sake of brevity, herein “plant expansive structure” refers to a vertically aligned plant supporting expansive structure, comprising a front layer of a corrugated plastic with an elastic memory that supports the plant from seed to harvest and a rear layer of a membrane that holds on to the rear of said front layer by surface tension of a nutrient solution.

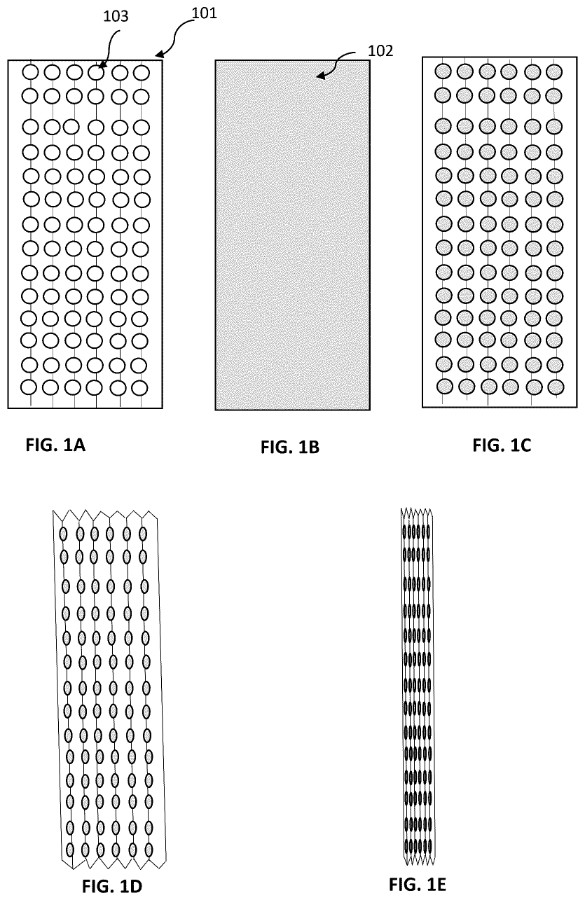

FIG. 1A illustrates a fully expanded corrugated front sheet 101 with cutouts 103. The corrugated material of the expansive front sheet 101 that holds the plant is composed of a substance with an elastic memory.

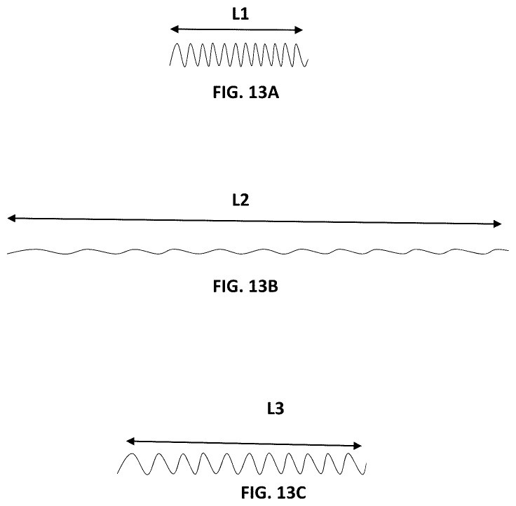

Certain plastics with elastic memory have the ability to return to its original folded shape after unfolding and holding in the unfolded position for a period of time. The return to the original folded position may be substantial or partial, preferably returning to atleast 30 to 50% of its previously folded position. More specifically, elastic memory herein refers to the folded plastic being able to return to its original folded shape after being held in a flexed position for a period of time. Hence, only a few materials such as solid thin sheet forms of polyethylene terephthalate (PET), biaxially oriented polyester film (BOPET), high density polyethylene (HDPE), thin fiberglass composite sheets etc. are suitable. Forms of cloth are not suitable as they do not have elastic memory to come back partially or fully to the original thermally set folded state. FIG. 13A illustrates a compressed plant expansive structure.

FIG. 13B illustrates an almost fully expanded plant expansive structure (>80% expanded state).

FIG. 13C illustrates the plant expansive structure after the fully expanded plant expansive structure of FIG. 13B is released to come to its close to its natural compressed state due its elastic memory.

FIG. 1B illustrates a disposable thin membrane rear membrane 102, composed of a porous material that allows roots to penetrate to the rear aeroponically misted cavity. The rear membrane layer is a porous material, with either micro or macro pores to allow for passage of water and fine roots of the germinating seed. Example of the porous membrane include soft tissue paper, for example single ply tissue like paper of 15 to 20 micron thickness. Preferably, the disposable membrane 102 is a biodegradable material such as of cellulosic material. Once, the plants are harvested, the rear disposable membrane 102 along with the roots are rotary wiped cleaned. Dirt or plant residue does not adhere to the smooth, thin and non porous material of the frontal layer 101. Hence, the cleaning process post harvest is convenient given the advantages of a smooth frontal layer 101 and easily wipe removable and disposable rear layer 102. The plant expansive structure has two distinct layers that are separate and not adhesively or stitch attached. The rear layer 102 merely clings to the front layer 101 by surface tension of the aqueous nutrient solution. The rear layer 102 is preferably a disposable layer and a frontal specific plastic layer 101 is reused. The frontal layer 101 has cutout holes for the deposition of seeds, and the continuous rear layer 102 seals the holes. The seeds are positioned in the holes, and lie over the supporting rear layer 102.

The plant expansive structure that house the plants increase photon capture efficiency and therefore provide significant energy savings. For example, in the first four days post germination, the rows of seeds are adjacent to each other with little or no discernible gap along the direction of the row. The photons from the LED are not wasted at this stage by striking the surface underneath, and instead make contact with the sprouted seedling. The plant expansive structure is compressed in this early stage to 17% of the final expanded stage. Exemplarily, in the subsequent four days, i.e. in the exemplary second stage, the plant expansive structure is expanded to 33% of its final expanded stage. Exemplarily, in the subsequent four days, i.e. in the exemplary third stage, the plant expansive structure is expanded to 50% of its final expanded stage. Exemplarily, in the subsequent four days, i.e. in the exemplary final fourth stage, the plant expansive structure is expanded to 100% of its final expanded stage. In all these stages, as the plant grows, the spacing between the plants increase, and therefore light is not wasted by striking the underlying surface.

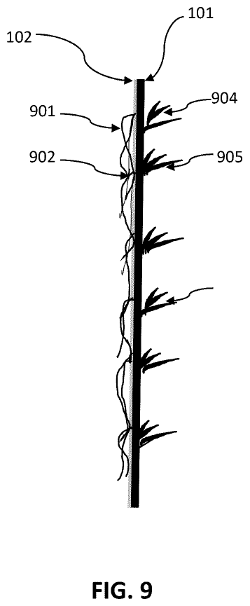

FIG. 9 illustrates a surface tension attached two layered material displaying the interlocking of roots between upper 904 and lower plants 905. Consider the germinated plants 904 and 905, with plant 904 higher positioned than plant 905. After germination, the roots 901 of plant 904 moves down and interlocks with the roots 902 of plant 905. Surprisingly, it is found that even a thin 20 micron thin cellulosic rear layer 102 does not tear by the plant weight because the interlocking roots of vertically adjacent plants create a rear structural grid of roots that takes the entire load, and transfers it to the front layer 101. Surprisingly, the wet and weak 20 micron cellulosic rear layer 102 maintains structural integrity, it does not break or allow cavities, and does not allow the mist from entering the plant leaf zone from the misted root zone.

In another embodiment, the porous membrane rear layer 102 may also comprise other types of bonded fibers with yields and allows easy penetration of roots.

FIG. 1C illustrates a fully expanded corrugated front sheet 101 with a thin membrane rear membrane 102 attached by water surface tension to the front sheet 101. Surprisingly, the surface tension based attachment of thin rear porous layer 102 is sufficient to hold the plant in its multiple stages of growth, and the surface tension does not allow the rear layer to dislodge from the front layer 101.

FIG. 1D illustrates a partially compressed corrugation of the front sheet 101 with rear membrane 102. For example, a 48 inch wide expanded corrugated front sheet 101 is compressed to 24 inches.

FIG. 1E illustrates a fully compressed corrugation of the front sheet 101 with rear membrane 102. For example, a 48 inch wide expanded corrugated front sheet 101 is compressed to 6 inches. This fully compressed plant expansive structure is ready for the deposition of seeds.

A vertically aligned plant supporting expansive structure comprises a front layer 101 of a corrugated plastic with an elastic memory that supports the plant from seed to harvest. A rear layer 102 of a thin film cellulosic disposable and biodegradable membrane holds on to the rear of the front layer 101 by surface tension of a nutrient solution. Artificial plant grow lighting illuminate plants supported on the front layer. Aeroponic misters are positioned behind the rear layer 102. Two of the vertically aligned plant supporting expansive structures with their respective rear layers 102 face the misters and create an enclosed aeroponic misting space.

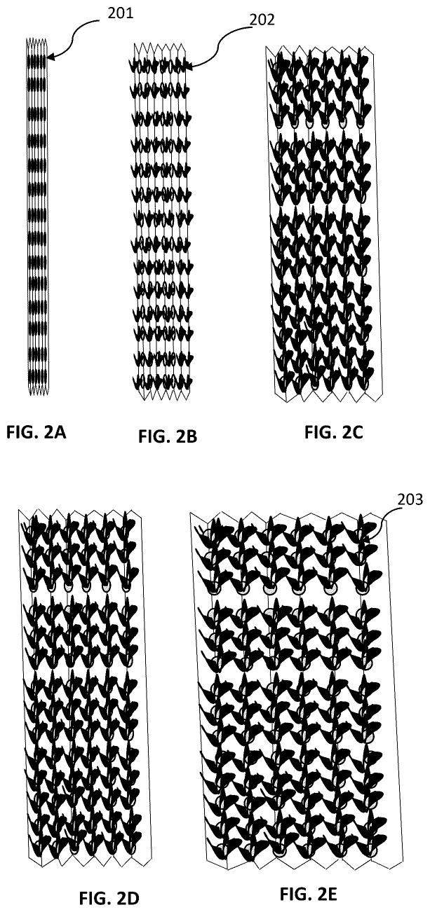

FIG. 2A illustrates a compressed corrugated front sheet with cutouts 201, along with seeds deposited in the cutouts. Described herein is a technique and apparatus for depositing seeds on a plant expansive structure 201. The plant expansive structure 201 exposes a continuity of seed holes that appear continuous. Seeds are deposited on top of the cellulosic surface in a linear pattern.

The folded plant expansive structures with seeds are preferably stored in a dark humid zone for germination. However, in the case of lettuce, it is preferable to expose the seeds to light from the second day onwards to avoid stem stretching and subsequent weakening of the lettuce seedlings.

FIG. 2B illustrates a first level of expansion of the corrugation of the front sheet with rear membrane, displaying germinated seeds 202. Exemplarily, in the first stage of germination, only the first set of leaves emerge from the seeds, they are not true leaves.

FIG. 2C illustrates a second level of expansion (higher than the first level of expansion), displaying young seedlings. The young seeds develop a first set of true leaves, typically five to eight days post germination.

FIG. 2D illustrates a third level of expansion (higher than the second level of expansion), displaying seedlings when the second set of leaves have fully formed. Exemplarily, the plants may be about 5 to 7 cm tall with 1 cm or longer true leaves.

FIG. 2E illustrates a fourth level of expansion (higher than the third level of expansion), displaying young plants 203.

Exemplarily, baby greens may be harvested at the end of a stage wherein the plant height is about 10 cm.

The stages illustrated above are exemplary, and the grower may set different expansion levels depending on the crop type and the preferred time to harvest.

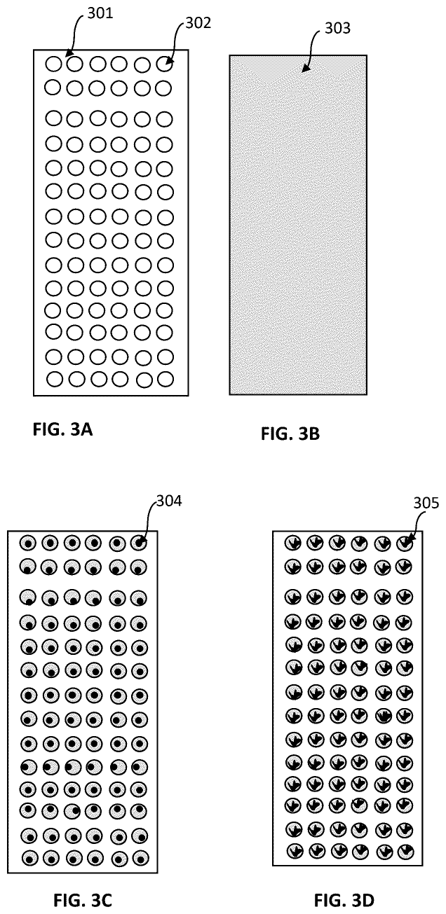

FIG. 3A illustrates a front sheet 301 with cutouts 302.

FIG. 3B illustrates a root penetrable thin film membrane 303, such as a cellulosic layer.

FIG. 3C illustrates seed placements 304 in the cutouts with the rear backing of a root penetrable thin film membrane 303.

FIG. 3D illustrates seedling growth 305 in the cutouts 302 with the rear backing of a root penetrable thin film membrane 303.

FIG. 3A to FIG. 3D illustrate embodiments without folds in the plant growth structure.

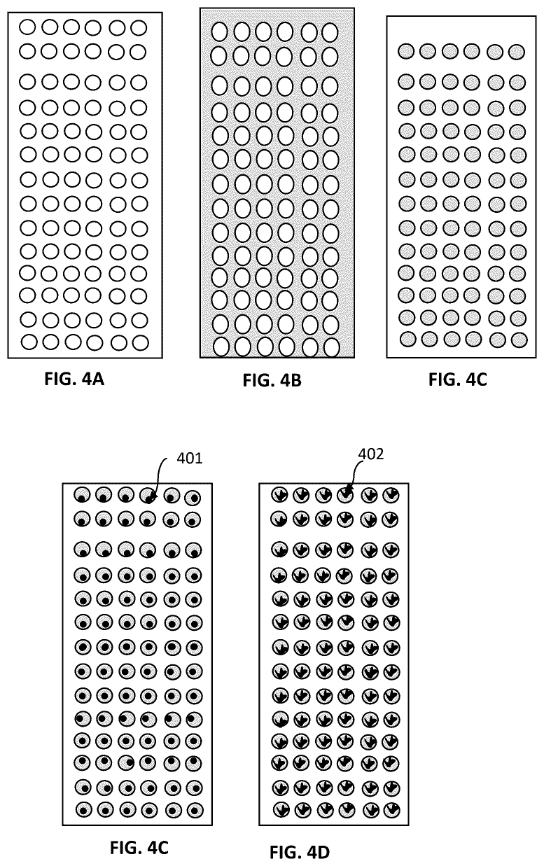

FIG. 4A illustrates a front sheet 404 with cutouts 405. FIG. 4B illustrates a thin plastic film 401 with cutouts. The thin plastic film 401 is held by surface tension of water adhered to the front sheet 404, the cut outs in the thin plastic film 401 is staggered with the cutouts in the front sheet 404, i.e. it is ensured that the cutout holes do not overlap.

FIG. 4C illustrates seed placements in the cutouts with the rear backing of the thin plastic film with cutouts. Preferably, the seeds 401 are placed in between the front and rear sheets (not shown). In a humid environment, the seeds germinate and the gravitrophic roots move vertically downwards, slip between the front and rear sheets, and emerge into the aeroponic cavity after exiting through the cutout in the rear sheet. The cutout holed shown in the figures are exaggerated for the purpose of explanation clarity. Exemplarily, they may be a few multiples of diameter of the seeds.

FIG. 4D illustrates seedling 402 growth.

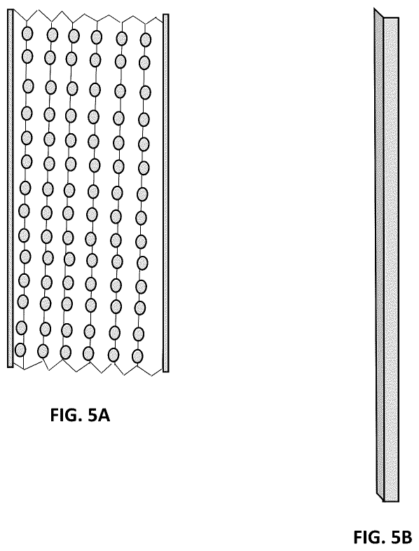

FIG. 5A illustrates a plant expansive structure with L angles attached at its distal side ends. The L angles provide a stiff edge for handling purposes.

FIG. 5B illustrates an L angle, used for attaching at the distal side ends of the plant expansive structure. The L Angles are composed of a bend resistant material, such as Stainless steel or aluminum. High tensile plastic L angles may also be used.

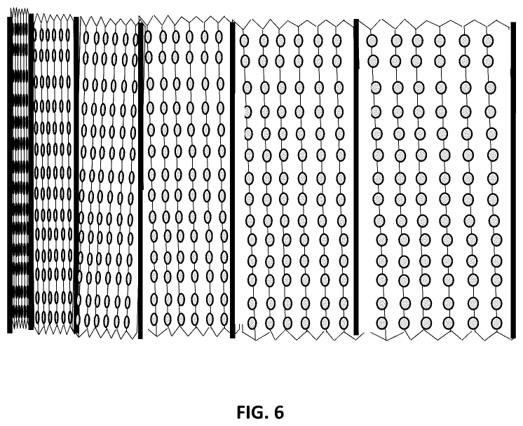

FIG. 6 illustrates a side elevation view of jointed plant expansive structures with L angles and L angle joint accessories used to join successive plant expansive structures. Instead of L angles other means of attachment of adjacent plant expansive structures may be accomplished, such as through the use of adjacent flats attached by hooks or clips, wherein the flats are riveted to the distal sides of the plant expansive structures.

In another embodiment, in continuous plant grow systems, the ends of the plant expansive structures may be directly jointed with flexible fasteners without the need for stiff L angles of structures.

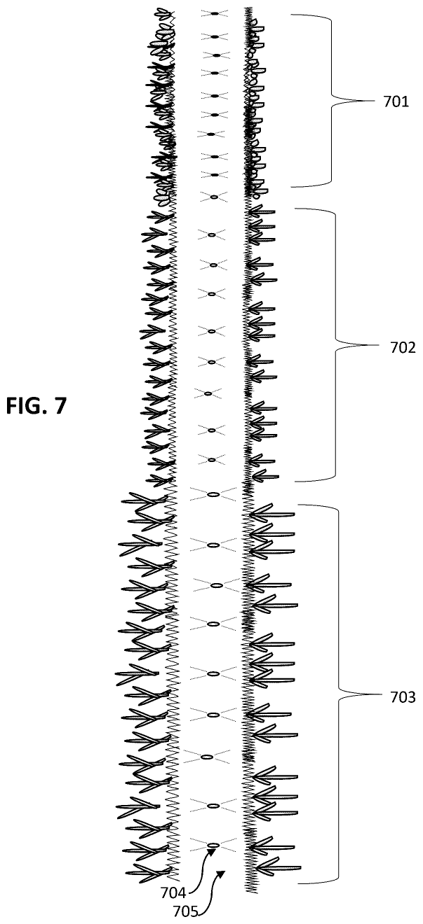

FIG. 7 illustrates a top sectional view of the continuous long plant expansive structure with plants in multiple stages of growth. Exemplarily, Stage 701 illustrate the seeds just after germinating. Stage 702 illustrates the plant growth at days 2 to 7 past germination, and stage 703 illustrates plant growth at days 7 to 20 past germination.

The internal misters 704 provide nutrients to the roots that penetrate to the aeroponic cavity 705.

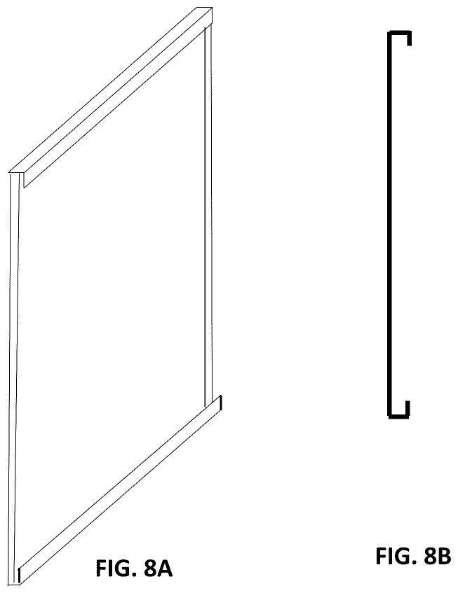

FIG. 8A illustrates a side angled view of the frame that supports the plant expansive structure. Two frames with rear root zone layers facing each other enclose an aeroponic spray zone.

FIG. 8B illustrates a sectional view of the frame that supports the plant expansive structure.

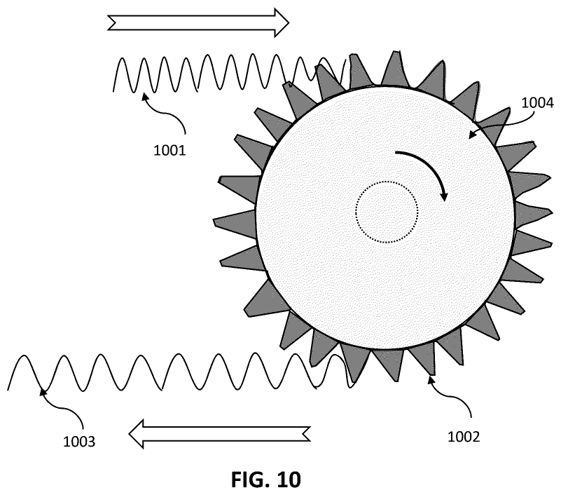

FIG. 10 illustrates a specially teethed sprocket 1004 driving the controlled movement of the plant expansive structure 1001. The teethed sprocket's teeth 1002 interlock with the folds of the plant expansive structure 1001 and drives the movement of the plant expansive structure 1001. For example, when expansion and movement is to be achieved in a more compressed state of the plant expansive structure 1001, i.e. in the early stages of plant growth, a sprocket 1004 with a greater number of teeth are utilized. For example, if a 6 cm diameter sprocket with 20 teeth drives a continuous plant expansive structure with two revolutions, a 6 cm diameter sprocket with 10 teeth will rotate only once to maintain sheet tension when the same plant expansive structure is passed continuously over both the before mentioned sprockets.

For given sprocket diameter, sprockets with decreasing number of tooth are utilized to drive the plant expansive structure as the plant grows from one stage to the next.

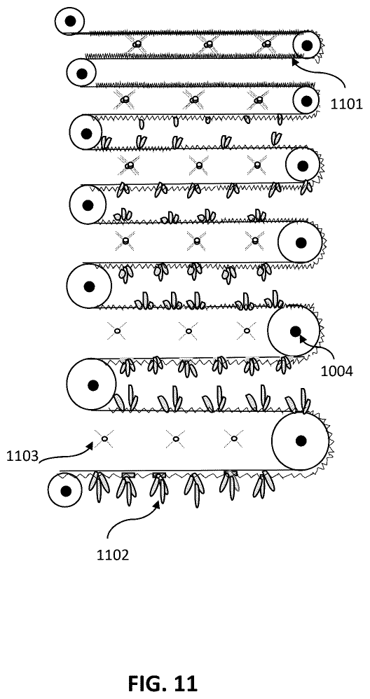

FIG. 11 illustrates a top view of open loop based continuous plant expansive structures in an aeroponic system with misters 1103 being successively expanded in different stages. Sprockets 1004 engage and drive the plant expansive structures along a continuous path. After harvest in the final stage, a new plant expansive structure with seeds 1101, or a plant expansive structure with seeds that have just germinated is affixed to the front section of plant expansive structures already present in the aeroponic plant growth system. The plants 1102 in the plant expansive structures at the end of the loop are harvested, and that end section of the harvested plant expansive structures are taken out of the system for cleaning. In another embodiment, the plant is cleaned in proximity of the system while the plant expansive structure to be harvested is still attached to the preceding plant expansive structure.

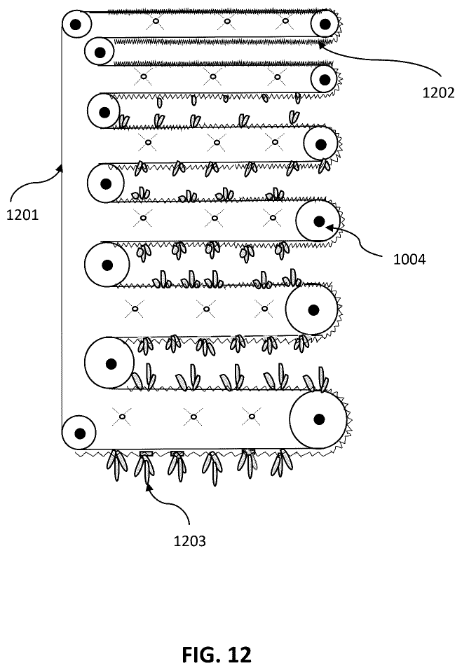

FIG. 12 illustrates a top view of closed loop 1201 based continuous plant expansive structures being successively expanded in different stages. Sprockets 1004 engage and drive the plant expansive structures along the continuous path. In the earlier stages of plant growth, the seedlings are closer together as the plant expansive structure is in a relatively higher folded state 1202, and as the plant expansive structure progresses to the final stages, at the point of harvest with mature plants 1203, the plant expansive structures are close to being fully expanded or are fully expanded. In the closed loop system, the plant expansive structures are harvested and cleaned while still in the continuous loop, new cellulosic layer 102 is attached to the rear of the front sheet 101, post cleaning and removal of the earlier cellulosic layer with roots. The plant expansive structure is again compressed, seeds are then deposited on the front layer 101, and the growth process repeats.

FIG. 13A illustrates a compressed plant expansive structure of compressed length L1.

FIG. 13B illustrates an almost fully expanded plant expansive structure of length L2 (>80% expanded state).

FIG. 13C illustrates the length of plant expansive structure L3 after the fully expanded plant expansive structure of FIG. 13B is released to come to its natural compressed state due its elastic memory. It is preferable for L3/L1 to be less than 3.0. Exemplarily, L2/L1=6. L2/L3=2.

The folded sheet 101 is manufactured by thermally forming a plastic sheet into folds using a corrugation machine. In the corrugation machine, the sheet is heated and softened by heaters that heat the plastic sheet close to, or at its softening point. A measure of softening point is Vicat hardness. Vicat hardness reflects the softening point for plastics. The Vicat softening temperature (VSP) test is a standard test (ASTM D1525 and ISO 306) which determines the temperature at which the plastic sheet is penetrated to a depth of 1 mm by a flat-ended needle with a 1 mm2 circular or square cross-section.

Alternatively, the material of the front layer 101 may be composed of shape memory polymers. Shape memory polymers ‘remember’ their original shape and return to that shape provided a stimulus, such as light or heat, irradiation with infrared light, immersion in water, and application of electric or magnetic fields.

In other embodiments, the plant expansive structure can expand in two dimensions, for example with pyramidal expansive origami type foldings.

The top structural layer 101 is a flexible weight bearing layer, for example a thin folded plastic such as biaxially oriented polyester film, BOPET or PET. Other forms of plastic such as high density polyethylene (HDPE) may also be used.

PET refers to Polyethylene terephthalate (PET), an aliphatic polyester. PET has a semi-crystalline form when stable, and is recylable. PET sheets composed of a thermoplastic polyester resin is thermoformable and ideally suited for the folded plastic sheet application. It's smooth surface is resistant to scratches and does not allow dust and dirt to adhere easily to its surface. Such dirt can be relatively easily removed from the surface by the rotary swiping action of an automated brush or through reciprocating wipers.

The front sheet 101 can be light blocking as well as reflective by one of three techniques. The plastic sheet may be composed of a white opaque pigment that is reflective in the direction of the plants. Alternatively, a metallized PET sheet will both reflect light towards the plant side and as well as block out light in the root zone. An example of a metallized PET sheet is a Aluminum coated sheet. Alternatively, the rear of the plastic sheet facing the roots may be painted with a light blocking paint. Alternatively, a secondary dark colored ing plastic sheet may be fused to a white reflective plant facing plastic sheet.

The front layer 101 is thermally crease pleated with a memory to partially fold back.

The rear layer is preferably a porous surface that allows roots to easily penetrate. Exemplarily, it is a cellulosic layer that is composed of loosely held cellulosic fibers. The loose hold of cellulosic fiber is accomplished by one or more of the following techniques: use of adhesives within the cellulosic layer with lower fiber bonding strength, addition of fiber lubricants, additives that reduces the bond between fibers etc. Exemplarily, the rear layer is a single ply or two ply sheet of softened bonded cellulosic fibers.

In another embodiment, the rear cellulosic layer may be selectively punched and made porous in the region of the cut hole to allow easy passage of the roots.

The rear cellulosic layer may additionally contain a controlled release fertilizer (CEF). Exemplarily, the relative proportion of Nitrogen Phosphorous Potassium (NPK) in the controlled release fertilizer may be customized based on crop type. Exemplarily, the rear cellulosic layer may be infused with humic acid prior to seeding. It has been observed that seedlings develop higher chlorophyll content in their cotylydons and first set of true leaves when the rear cellulosic layer 102 has been pre imbibed with nutrients or other growth enhancing materials.

The rear cellulosic layer 102 may also contain carbon particulates in the form of powdered charcoal or activated carbon, with the ability to absorb non desirable growth inhibitory organics from the nutrient mix, such as root exudates.

Described herein is a technique and apparatus to fold a fully expanded or semi expanded plant expansive structure back to a fully folded state. After the plant expansive structure is fully expanded in the final growing phase of the plant, it may not fully recover to its folded state. However, atleast a 30% folded state is sufficient for the plant expansive structure to be recompacted to a fully folded state, enabled by the elastic memory of the specific plastic used in the plant expansive structure. If the plastic has poor memory, then it would extend completely and it will not be feasible to refold the plant expansive structure into a compacted state for reuse. The elastic property is essential because on release for expansion, the folds push out and uniformly expands. This uniform expansion through pull or push is feasible through the elastic strain energy stored in the compressed plant expansive structure. Microfleece cloths are inelastic and cannot be used in the disclosed plant growing system. The full folding apparatus feeds the partially expanded plant expansive structure between a top and lower guide that holds the plant expansive structure in a planar state. Rotary soft brush rollers push and compact the folds to a fully folded state after over extension of the plant expansive structures.

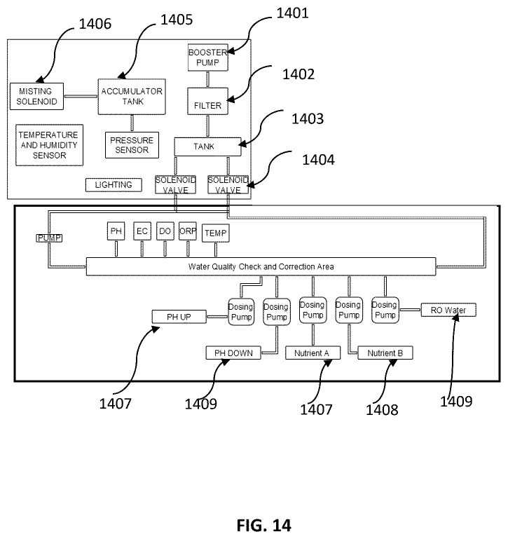

FIG. 14 illustrates an active component level architecture of the underlying aeroponics system. The aeroponic system comprises reservoir/tank 1403, misters, filters 1402, control system, pressure tank 1405, solenoids 1404, 1406, pressure sensors, flow sensors, booster pumps 1401 and other sensor modules along with Internet of things (IOT) Connectivity. The misters are positioned on pipes. Examples of pipe material includes high tensile pressure bearing plastics or stainless steel. The misters preferably provide fine mist, with droplet sizes preferably in the range 50 microns. Very small droplet sizes, such as 20 micron droplets tend to “evaporate” and are not effective at providing a substantial nutrient film layer on the roots. Excess atomization of the droplets introduces excessive root hair, and the plants grow a greater portion of roots instead of the desired marketable higher shoot. The mister module comprising the pipes and connected misters need to serviceable, the misters need to be easily replaceable and the mister functional performance must be easily gauged. Performance parameters of the misters include output flow rate in milliliters per minute, and spray pattern shape consistency. In some cases, a failed mister may not mist, instead drips or linearly jets out nutrients. In addition, the misters at a pressure of about 100 psi will preferably create droplets in the range of 50 microns. Mist droplets larger than 100 microns may not provide the aeroponic growth advantage. The misters must be easily removed for replacement or cleaning and subsequent refitting. Misters are connected in a fashion that a minimal level of redundancy is established.

Carbon dioxide in exemplarily set in the range of 500 to 2400 ppm. The effectiveness of raising the CO2 concentration dependent on a number of plant growth factors, such as the lighting intensity, type of crop, temperature, ventilation type and external air exchange magnitude and frequency. Stale air and the boundary layer around the leaf needs to refreshed with C02 enriched air movement.

Exemplarily, CO2 is supplied in the form of liquid carbon dioxide. Compared to other sources of CO2, liquid CO2 is purer, with no related additional heat or moisture, providing the ability to effectively control CO2 levels and the ability to guide CO2 in the midst of the crop. Exemplarily, the consumption of CO2 is estimated to be about 0.12-0.20 kg/hr/(100 m2 of growing surface).

The light sources are preferably linear light sources such as LEDs (light emitting diode). The linear light sources may be in the form of batten lights, LED strip lights or LED rope lights. The LED can be full spectrum (380 nm-730 nm), or one or more of a combination of red, blue, green, white, infrared, far red and UV. Certain LED wavelengths are suitable for specific stages of plant growth. For example, LEDs with a higher concentration in the blue wavelength keep the plants compact, increases pigmentation and does not dry out the cotyledons that have just emerged from the seeds. Red light enables plant extension, and stimulates flowering and fruiting. Far red LEDs create plant leaf surface and stem length elongation by initiating shade responses. Green light penetrates a canopy deeper than other light wavelengths, providing the lower and older leaves to photosynthesize and maintain freshness. In high density farming, it is essential to maintain a minimum level of photosynthesis in the lower leaves, and reduce the rate of lower leaf senescence.

Filters 1402 filter the recirculating nutrient media to remove particulate matter that may clog the fine misting nozzles. The filtration system comprises of both coarse filters and fine filters. Coarse filters filter out seed shells, decayed vegetation, pieces of roots etc. Examples of filters include particle strainers and basket filters. The fine filters, for example filtration pores in the range of 50 microns removes fine particulate matter, both organic and inorganic. Examples of organic matter include algae remnants, decayed matter etc. and inorganic includes fine rust particles, chemical deposits, nutrient deposits etc. In some cases, the filters may support colonization of beneficial bacteria and fungi that enhance plant growth and health.

The filtration unit can have inline filtration components as well as edge filtration modules located at the reservoir. The filtration unit may also be columnar with multiple layers of filtration starting from coarse to fine. There may be an activated carbon filtration layer that removes organic toxins, such as root exudates that may inhibit plant growth.

The reservoir is communication coupled to a nutrient dosing system. The nutrient dosing system comprises one or more of Macronutrient part A concentrate, Micronutrient part B concentrate, water with low total dissolved solids and other additives. Examples of inorganic fertilizers include Calcium nitrate, calcium Ammonium nitrate, Potassium nitrate, chelated Iron, Potassium phosphate, Magnesium sulfate, Borax, Sodium molybdate, Zinc sulfate, Copper sulfate, and Manganese sulfate.

The reservoir may also include UV-C lighting (short-wavelength, typically, 200 to 280 nanometers of the ultraviolet spectrum) to sterilize the nutrients. The UV-C lighting is preferably located at point where there is turbulent movement of the nutrients within the reservoir tank. UV-C reduces the chance of Algae outbreaks. Some UV-C systems come with inbuilt flow modules. Inline UV-C clairifiers may be used in the return line into the tank.

The reservoir may be temperature controlled using a chiller or heater. Exemplarily, electric resistance heaters or forced hot air heaters may be utilized for heating. Higher oxygenation levels are achieved at lower temperatures. The reservoir is aerated using air pumps, thereby avoiding staleness and maintaining high oxygen levels.

The reservoir may include a drain that enables reservoir fluid exchange, and the drain may be automated with a motor and associated controls.

The control system that controls and monitors all input parameters and output performance, comprises multiple modules such as Processing modules, Sensing modules, Communication modules and Actuation modules. Client user interfaces may be provided in one or more of the following: User Interface (UI) displays at site, mobile phone applications, or web apps accessible for personal computers.

Examples of processing modules comprises robust programmable logic controllers (PLC), and versatile Arduino, Raspberry Pi etc. In another embodiment, data is collected from the farm via sensors, and transmitted via transmission modules.

Communication modules, i.e the transmission and receiver modules may comprise Ethernet based connections from the farm to the internet cloud or central server, or Wi-Fi based connections to the cloud or central server. The Wi-Fi system may comprise access points, transceivers, routers and gateways. In another embodiment, the communication modules may transmit data and receive instructions from distributed computing device networks.

Sensors include one or more of temperature sensors, humidity sensors, pressure sensors, flow sensors, carbon dioxide sensors, dissolved oxygen sensors, pH sensors, electrolytic conductivity sensors, light intensity sensors, light wavelength sensors, photosynthetically active radiation (PAR) sensors, imaging sensors, wind anemometers, level sensors. Discrete reservoirs supply pH up adjustment solution 1407, pH down adjustment solution 1409, macronutrients 1407, micronutrients 1408, and reverse osmosis filter water 1409.

### For the Purpose of Conserving Water, Water Condensate From the Dehumidifier, Air conditioner/HVAC system may be collected and fed into the water supply tank post filtering or sterilization.

The software intelligence modules actuates and modulates the actuators. Intelligence and controls are applied for regular operations of various components as well as predictive maintenance of the components.

Alarms are controlled by the intelligence modules or at a local component level. For example, if the CO2 level exceeds 1500 mm, the alarm is actuated by the input from a localized sensor at a local decision level, or is actuated by a central processing module. The alarm may be in the form of an online electronic message to the farm operator through SMS, MMS, Social Media Group message, etc. The alarm may also be in the form of one or more of lighted LEDs, flashing lights, warning audio announcements and sirens.

Actuators include solenoids, pumps 1401, linear motion actuators, light switches, pH dosing pumps, Macronutrient dosing pumps, micronutrient dosing pumps, cameras, air blowers, mixing pumps, aeration pumps etc.

The plant growing plant expansive structures can be tagged to enable Produce Traceability Initiative (PTI) label-compliant with electronic produce traceability. The PTI system allows tracing the source of the produce, and identifies the path of the system from production to shipping. Contamination risk and allergen tracking can also be accomplished using PTI.

The software intelligence optimally recommends seeding schedule for a given target harvest. It suggests the number of seeds to be planted, type of plant to be planted (if not already defined), setting the DAS (days after seeding for the harvest) etc. The software intelligence optimally manages the harvest queue.

The plant expansive structures may be RFID tagged or may be tagged with other types of electronic signatures. As the plant expansive structure moves across over time, a camera captures plant properties and inferences from image analytics may be tagged to the RFID and such information is stored either locally or in the cloud. Examples of image analytics include size of crop, chlorophyll pigmentation level, coloration, nutrient deficiency signalling coloration and patterns.

The aeroponic system disclosed herein can be used for multiple end grow applications, including but not limited to growing greens, baby greens, microgreens, strawberries, and even larger crops such as rice and corn. The systems can be implemented in a conventional greenhouse, vertical farm in a shed, research environments, home and hobby, and in preferably controlled environment agriculture environments.

The sprayed nutrients that flows over the roots and internal walls of the plant expansive structures are collected in rack drains, and the rack drains further feed into a main drain. The drains may be designed with a small sloping gradient, for example 1 cm every meter to facilitate water flow. The section of the rack drains may have a central U portion to facilitate water aggregation and faster drain through concentrated central flow. The nutrient solution from the main drain is either gravitationally fed to the reservoir tank, if the reservoir tank is at a lower level, or the nutrient solution in pumped upto a larger reservoir.

The apparatus described herein advantageously ensures that as plants grow, the spacing between the plants is adjustably increased to accommodate light focus and induce airflow circulation.

The foregoing examples have been provided merely for explanation and are in no way to be construed. While the vertical farm module has been described with reference to particular embodiments, it is understood that the words, which have been used herein, are words of description and illustration, rather than words of limitation. Furthermore, although the vertical farm module has been described herein with reference to particular means, materials, and embodiments, the vertical farm module is not intended to be limited to the particulars disclosed herein; rather, the design and functionality extends to all functionally equivalent structures and uses, such as are within the scope of the appended claims. While particular embodiments are disclosed, it will be understood by those skilled in the art, having the benefit of the teachings of this specification, that the vertical farm module disclosed herein is capable of modifications and other embodiments may be effected and changes may be made thereto, without departing from the scope and spirit of the vertical farm module disclosed herein.

1. A vertical aeroponic plant growth system, comprising:
a vertically aligned plant supporting expansive structure, comprising;
a front layer of a corrugated plastic with an elastic memory that supports the plant from seed to harvest;
a rear layer of a thin film cellulosic disposable and biodegradable membrane that holds on to the rear of said front layer by surface tension of a nutrient solution;
artificial plant grow lighting illuminating plants supported on said front layer;
aeroponic misters positioned behind said rear layer, wherein two of said vertically aligned plant supporting expansive structures with their respective rear layers face said misters and create an enclosed aeroponic misting space.

2. The aeroponic plant growth system of claim 1, wherein said front layer is composed of a biaxially oriented polyester film.

3. The aeroponic plant growth system of claim 1, wherein said front layer is composed of high density polyethylene.

4. The aeroponic plant growth system of claim 1, wherein said front layer includes cutouts for positioning seeds and for allowing roots to penetrate into said misting space through said rear layer.

5. The aeroponic system of claim 1, wherein multiples of said vertically aligned plant supporting expansive structures are compressed at different levels and jointed continually to create continuous long plant growing surfaces.

6. The aeroponic system of claim 1, wherein said continuous vertically aligned plant supporting expansive structures form an open loop aeroponic chamber.

7. The aeroponic system of claim 1, wherein said continuous vertically aligned plant supporting expansive structures form a closed loop aeroponic chamber.

8. The aeroponic system of claim 1, wherein said vertically aligned plant supporting expansive structures is expanded at the stage when plants overgrow and their canopy or leaves begin to over shade each other.

9. The aeroponic system of claim 1, wherein said vertically aligned plant supporting expansive structures is compressed at the level wherein atleast 95% of light from said artificial lighting strikes a plant part rather than the surface of said front layer.

10. The aeroponic system of claim 1, wherein roots from plants positioned one above the other on said vertically aligned plant supporting expansive structures interlock and therefore create a continuous grid support structure that holds the plants onto the vertically aligned plant supporting expansive structure.

11. The aeroponic system of claim 1, wherein sprockets with tooth engage with the folds of the corrugation of the front layer, and drives the movement of the vertically aligned plant supporting expansive structure.

12. The aeroponic system of claim 1, wherein said rear layer is pre-imbibed with one or more of slow release fertilizers, humic acid, activated carbon or charcoal.

13. An vertical aeroponic plant growth system, comprising:
a vertically aligned plant supporting structure, comprising;
a front layer of a plastic that supports the plant from seed to harvest;
a rear layer of a thin film cellulosic disposable and biodegradable membrane that holds on to the rear of said front layer by surface tension of a nutrient solution;
artificial plant grow lighting illuminating plants on said front layer;
aeroponic misters positioned behind said second layer, wherein two of said vertically aligned plant supporting expansive structures with their respective rear layers face said misters and create an enclosed aeroponic misting space.

14. An vertical aeroponic plant growth system, comprising:
a vertically aligned plant supporting structure, comprising;
a front layer of a plastic with a first set of cutouts that supports the plant from seed to harvest;
a rear layer of a plastic membrane with a second set of cutouts, wherein said rear thin plastic membrane holds on to the rear of said front layer by surface tension of a nutrient solution, and wherein said first set of cutouts and set second set of cutouts are offset and do not overlap;
artificial plant grow lighting illuminating plants on said front layer;
aeroponic misters positioned behind said second layer, wherein two of said vertically aligned plant supporting expansive structures with their respective rear layers face said misters and create an enclosed aeroponic misting space.
